(19) United States
(12) Patent Application Publication
(10) Pub. No.: US 2009/0123796 A1
(43) Pub. Date: May 14, 2009

(54) HYDROGEN AND POWER GENERATION SYSTEM AND METHOD OF ACTIVATING HYDROGEN GENERATION MODE THEREOF

(75) Inventors: Koichi TAKAHASHI, Utsunomiya-shi (JP); Jun TAKEUCHI, Utsunomiya-shi (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/270,640

(22) Filed: Nov. 13, 2008

(30) Foreign Application Priority Data
Nov. 13, 2007 (JP) 2007-294478

(51) Int. Cl. H01M 8/06; H01M 8/04

(52) U.S. Cl. 429/17; 429/21

(57) ABSTRACT

A hydrogen and power generation system has a reforming device for producing a reformed gas from a reformable raw fuel, a combination fuel cell and ion pump operable selectively in a hydrogen generation mode and an electricity generation mode, an anode off-gas passage for supplying an anode off-gas discharged from an anode of the combination fuel cell and ion pump to a catalytic combustor, a cathode off-gas passage for discharging a cathode off-gas from a cathode of the combination fuel cell and ion pump, a cathode purge passage, which branches from the cathode off-gas passage and is connected to the anode off-gas passage, and a valve mechanism connected to the cathode purge passage.

### BACKGROUND OF THE INVENTION

1. Field of the Invention

The present invention relates to a hydrogen and power generation system comprising at least a reforming device and a combination fuel cell and ion pump, which is selectively operable in a hydrogen generation mode and an electricity generation mode when an anode thereof is supplied with a reformed gas from the reforming device. The present invention also concerns a method of activating the hydrogen generation mode of such a hydrogen and power generation system.

2. Description of the Related Art

Fuel cells are a system for generating DC electrical energy from an electrochemical reaction caused when anode and cathode are supplied with a fuel gas, i.e., a gas mainly containing hydrogen, and an oxygen-containing gas, i.e., a gas mainly containing oxygen.

For example, a solid polymer electrolyte fuel cell includes a power generation cell having a membrane electrode assembly (MEA) sandwiched between separators. The membrane electrode assembly comprises an electrolyte membrane in the form of a polymer ion exchange membrane, and anode and cathode that are disposed on respective opposite sides of the electrolyte membrane. Usually, a predetermined number of membrane electrode assemblies and a predetermined number of separators are stacked together in a fuel cell stack for use on vehicles such as automobiles, or for use in home energy stations for meeting domestic electric power needs.

The fuel gas supplied to fuel cells normally comprises a hydrogen gas, which is generated from a raw material such as a hydrocarbon material by a reforming device. Generally, the reforming device operates to produce a reformable raw gas from a raw hydrocarbon material such as methane, LNG, or the like, and then to reform the reformable raw gas according to a water vapor reforming process, a partial oxidation reforming process, or an automatic thermal reforming process, for thereby generating a reformed gas (fuel gas).

The fuel gas generated by the reforming device needs to be converted into highly pure hydrogen gas (refined hydrogen gas), which may be compressed for storage. To this end, a combination fuel cell and ion pump disclosed in Japanese Laid-Open Patent Publication No. 2007-505472 (PCT) has been employed.

The combination fuel cell and ion pump comprises an electrochemical cell having an anode inlet for receiving a fuel, an anode outlet for discharging the fuel, a cathode inlet for receiving an oxidizer, a cathode outlet for discharging at least one of the oxidizer, refined oxygen, and refined hydrogen, a first connector, and a second connector, and a controller for providing electric charges to the first and second connectors in order to cause the electrochemical cell to act as a fuel cell for generating electricity, and for providing potentials to the first and second connectors in order to cause the electrochemical cell to act as at least one of a hydrogen pump for refining hydrogen and an oxygen pump for refining oxygen.

The combination fuel cell and ion pump is selectively operable in a hydrogen generation (hydrogen pump) mode and an electricity generation (fuel cell) mode. When the combination fuel cell and ion pump is shut down, the cathode keeps a gas trapped therein, which is mainly composed of hydrogen and nitrogen, because of the remaining gas from a final phase of operation of the combination fuel cell and ion pump. When the hydrogen generation mode is subsequently activated, hydrogen refined in the cathode is mixed with the trapped gas and tends to be lower in purity.

One possible solution is to dilute the low-purity hydrogen existing in the cathode with a large amount of high-purity hydrogen gas refined in the cathode at the time the hydrogen generation mode is activated, thereby producing hydrogen gas having a prescribed purity level.

However, a system in which the combination fuel cell and ion pump is used as a home energy station is relatively small in structure, and the system is used mostly to produce small amounts of hydrogen gas. In order for the system to produce hydrogen gas having a prescribed purity level, the system would need to operate for a long period of time, and hence such a system would tend to consume a large amount of energy.

### SUMMARY OF THE INVENTION

An object of the present invention is to provide a hydrogen and power generation system, which is capable of reliably producing highly pure hydrogen gas within a short period of time when a hydrogen generation mode is started, and hence can be activated economically and efficiently. A further object of the present invention is to provide a method of activating a hydrogen generation mode of such a hydrogen and power generation system.

According to the present invention, there is provided a hydrogen and power generation system comprising a reforming device for producing a reformed gas by reforming a raw fuel mainly composed of hydrocarbons, the reforming device having a combustor as a heat source, a combination fuel cell and ion pump comprising an electrolyte electrode assembly having an electrolyte and a pair of anode and cathode disposed on respective opposite sides of the electrolyte, the combination fuel cell and ion pump being operable selectively in a hydrogen generation mode for delivering hydrogen in the reformed gas through the electrolyte to the cathode by supplying the reformed gas to the anode while applying a potential between the anode and cathode, and an electricity generation mode for generating electricity by supplying the reformed gas to the anode and supplying an oxygen-containing gas to the cathode while applying a potential between the anode and cathode, an anode off-gas passage for supplying an anode off-gas discharged from the anode to the combustor, a cathode off-gas passage for discharging a cathode off-gas from the cathode, the cathode off-gas passage having a cut-off mechanism connected thereto, a cathode purge passage connected to the cathode off-gas passage upstream of the cut-off mechanism, and a valve mechanism connected to the cathode purge passage.

When the hydrogen generation mode of the hydrogen and power generation system is activated, the reformed gas is supplied to the anode of the combination fuel cell and ion pump, thereby discharging refined hydrogen gas in the cathode of the combination fuel cell and ion pump into the cathode off-gas passage connected to the cathode. Therefore, low-purity hydrogen gas remaining in the cathode at the time of activation of the hydrogen generation mode is reliably purged from the cathode into the cathode off-gas passage by the refined hydrogen gas.

Consequently, hydrogen gas of a predetermined purity level can reliably be produced more economically and in a shorter period of time than if the low-purity hydrogen gas remaining in the cathode were sufficiently diluted in order to produce hydrogen gas having a predetermined purity level.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram showing an overall configuration of a hydrogen and power generation system according to a first embodiment of the present invention;

FIG. 2 is a detailed block diagram of the hydrogen and power generation system;

FIG. 3 is a block diagram of the hydrogen and power generation system operating in an electricity generation mode;

FIG. 4 is a flowchart of a method of activating a hydrogen generation mode of the hydrogen and power generation system;

FIG. 5 is a timing chart of the method of activating the hydrogen generation mode;

FIG. 6 is a block diagram illustrating the method of activating the hydrogen generation mode;

FIG. 7 is a block diagram showing an overall configuration of a hydrogen and power generation system according to a second embodiment of the present invention;

FIG. 8 is a block diagram showing an overall configuration of a hydrogen and power generation system according to a third embodiment of the present invention; and

FIG. 9 is a block diagram showing an overall configuration of a hydrogen and power generation system according to a fourth embodiment of the present invention.

### DESCRIPTION OF THE PREFERRED EMBODIMENTS

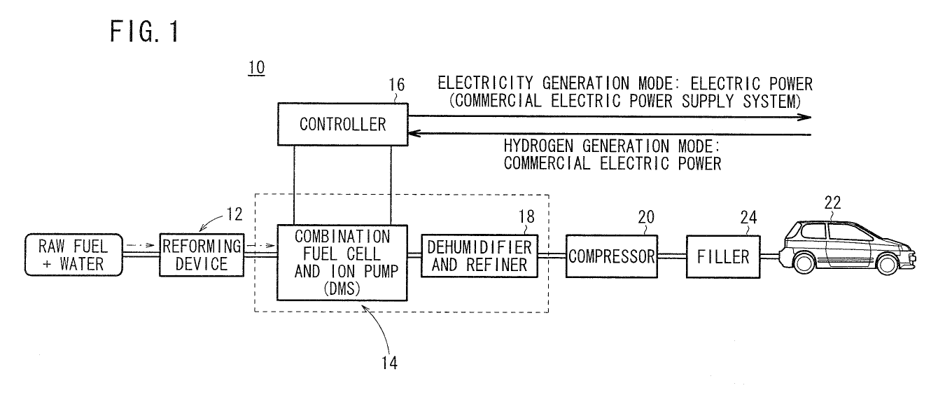

FIG. 1 shows in block form a hydrogen and power generation system 10 according to a first embodiment of the present invention. The hydrogen and power generation system 10 can be used as a home energy station connected to a commercial power supply system, and can operate to supply electrical power in order to meet domestic electrical power needs, i.e., to follow load fluctuations in homes.

The hydrogen and power generation system 10 generally comprises a reforming device 12 for producing a reformed gas by reforming a mixture of a raw fuel, e.g., a city gas, composed mainly of hydrocarbons and water vapor, a combination fuel cell and ion pump 14 selectively operable in an electricity generation mode and a hydrogen generation mode as described later, a controller 16 connected to the combination fuel cell and ion pump 14, for controlling the hydrogen and power generation system 10 in its entirety, a dehumidifier and refiner 18 for dehumidifying and further refining the refined hydrogen gas supplied from the combination fuel cell and ion pump 14, a compressor 20 for compressing the refined hydrogen gas supplied from the dehumidifier and refiner 18, and a filler 24 for filling a fuel cell vehicle 22 with hydrogen gas supplied as a fuel gas from the compressor 20.

The controller 16 has a function to apply electric charges to the combination fuel cell and ion pump 14 when the combination fuel cell and ion pump 14 operates in the electricity generation mode, and to apply potentials to the combination fuel cell and ion pump 14 when the combination fuel cell and ion pump 14 operates in the hydrogen generation mode.

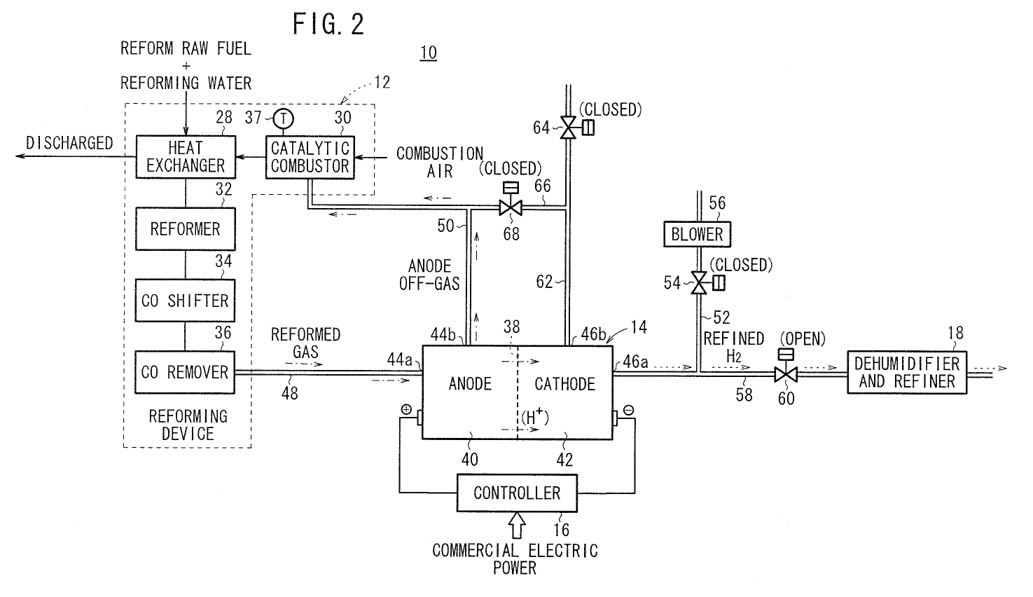

As shown in FIG. 2, the reforming device 12 comprises a heat exchanger 28 for producing a mixed fuel by mixing hydrocarbons such as methane (CH₄), ethane (C₂H₆), propane (C₃H₈), and butane (C₄H₁₀) contained in a city gas with water vapor, a catalytic combustor 30 for applying heat to the heat exchanger 28 in order to generate water vapor, a reformer 32 for producing a reformed gas by processing the mixed fuel according to a water vapor reforming process, a CO shifter (shift reactor) 34 for converting carbon monoxide and water vapor in the reformed gas into carbon dioxide and hydrogen according to a shift reaction, and a CO remover (selective oxidation reactor) 36 for adding a small amount of air to the reformed gas, and for reacting selectively absorbed carbon monoxide and oxygen in the air with each other in order to convert the selectively absorbed carbon monoxide into carbon dioxide. The catalytic combustor 30 is connected to a temperature sensor 37 that measures the temperature of the catalytic combustor 30.

The combination fuel cell and ion pump 14 comprises a membrane electrode assembly (electrolyte electrode assembly) including a solid polymer electrolyte membrane 38 sandwiched between an anode 40 and a cathode 42. Although not shown, a plurality of membrane electrode assemblies and a plurality of separators are alternately stacked together into a fuel cell stack. The solid polymer electrolyte membrane 38 may comprise, for example, an electrolyte membrane of hydrocarbon, or an electrolyte membrane of fluorine such as perfluorocarbon or the like.

The combination fuel cell and ion pump 14 has an anode inlet 44a for supplying the reformed gas to the anode 40, an anode outlet 44b for discharging the used reformed gas (anode off-gas) from the anode 40, a cathode inlet 46a for supplying air as an oxygen-containing gas to the cathode 42 and for discharging a refined hydrogen gas produced from the reformed gas in the hydrogen generation mode, and a cathode outlet 46b for discharging the used air from the cathode 42.

The anode inlet 44a and the CO remover 36 of the reforming device 12 are connected to each other through a reformed gas passage 48. The anode outlet 44b and the catalytic combustor 30 of the reforming device 12 are connected to each other through an anode off-gas passage 50.

The cathode inlet 46a is connected to a cathode inlet passage 52. A solenoid-operated valve 54 is connected to the cathode inlet passage 52, and a blower (compressor) 56 also is connected to the cathode inlet passage 52 upstream of the solenoid-operated valve 54. A hydrogen gas passage 58 is connected to the cathode inlet passage 52. Another solenoid-operated valve 60 is connected to the hydrogen gas passage 58 downstream of the junction between the cathode inlet passage 52 and the hydrogen gas passage 58. The dehumidifier and refiner 18 also is connected to the hydrogen gas passage 58 downstream of the solenoid-operated valve 60.

The cathode outlet 46b is connected to a cathode off-gas passage 62. A solenoid-operated valve 64, serving as a cut-off mechanism, is connected to the cathode off-gas passage 62. A cathode purge passage 66 branches from the cathode off-gas passage 62 upstream of the solenoid-operated valve 64. The cathode purge passage 66 is held in fluid communication with the anode off-gas passage 50 via a solenoid-operated mechanism (valve mechanism) 68. The solenoid-operated mechanism 68 should preferably have a reverse pressure-compatible structure, which operates to cut off a cathode off-gas flowing from the cathode outlet 46b, and to effectively block flow toward the cathode outlet 46b.

Normal operation of the hydrogen and power generation system 10 shall be described below.

When the hydrogen and power generation system 10 is activated, as shown in FIG. 2, the heat exchanger 28 of the reforming device 12 is supplied with a raw fuel (reformable raw material), such as a city gas or the like, together with reforming water. The heat exchanger 28 also is supplied with combustion heat from the catalytic combustor 30. Therefore, the reforming water supplied to the heat exchanger 28 is evaporated into water vapor, and a mixture of the raw fuel and the water vapor is supplied from the heat exchanger 28 to the reformer 32.

The reformer 32 processes the raw fuel with water vapor according to a water vapor reforming process in order to produce a reformed gas, which is supplied to the CO shifter 34 for carrying out a shift reaction. The reformed gas then is supplied from the CO shifter 34 to the CO remover 36 for promoting a selective oxidation reaction, from which the reformed gas is introduced into the reformed gas passage 48.

When the combination fuel cell and ion pump 14 operates in the hydrogen generation mode, the controller 16 applies potentials to the anode 40 and the cathode 42. The reforming device 12 supplies the reformed gas to the reformed gas passage 48, from which the reformed gas is supplied through the anode inlet 44a to the anode 40. No air is supplied from the blower 56 to the cathode 42.

At this time, the controller 16 applies a positive potential to the anode 40 and a negative potential to the cathode 42. A reaction represented by H₂→2H⁺+2e⁻ occurs at the anode 40, and hydrogen ions (H⁺) move through the solid polymer electrolyte membrane 38 to the cathode 42. A reaction represented by 2H⁺+2e⁻→H₂ occurs at the cathode 42, while the hydrogen is under an increased pressure.

Therefore, protons (hydrogen ions) move from the anode 40 to the cathode 42, which produces highly pure hydrogen gas. The hydrogen gas is introduced from the cathode inlet passage 52 into the hydrogen gas passage 58, which supplies the hydrogen gas to the dehumidifier and refiner 18. The dehumidifier and refiner 18 dehumidifies and refines the hydrogen gas. As shown in FIG. 1, the hydrogen gas is compressed by the compressor 20, and is delivered to the filler 24, which fills the fuel cell vehicle 22 with hydrogen gas when necessary.

As shown in FIG. 2, the reformed gas (containing unburned hydrogen gas) used by the anode 40 is delivered as an unburned gas from the anode outlet 44b, through the anode off-gas passage 50, and to the catalytic combustor 30. The unburned gas is burned in the catalytic combustor 30 as a result of combustion air that is supplied to the catalytic combustor 30, thus supplying heat to the heat exchanger 28.

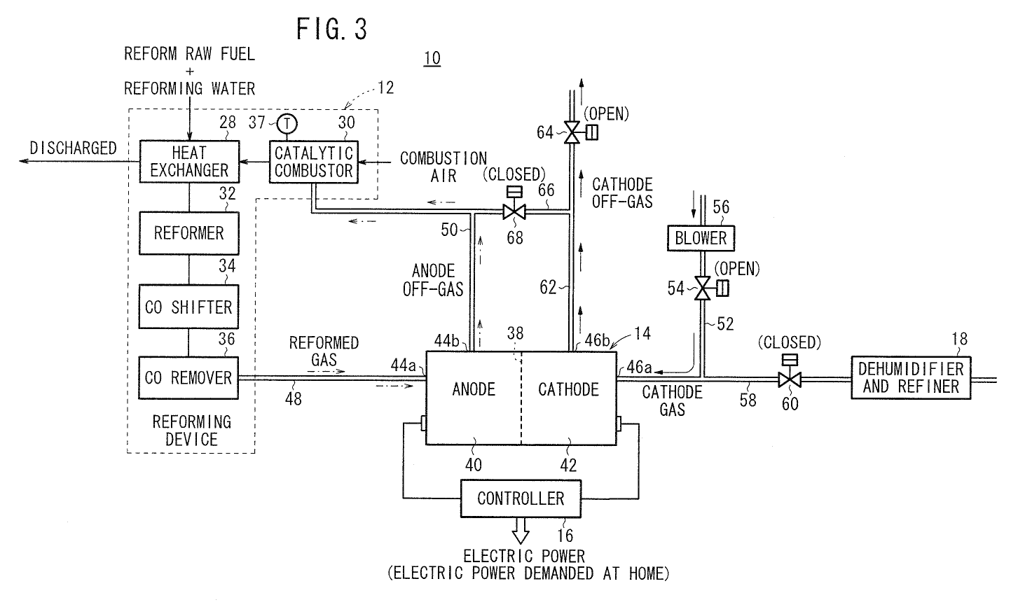

When the combination fuel cell and ion pump 14 operates in the electricity generation mode, as shown in FIG. 3, the controller 16 applies electric charges to the anode 40 and the cathode 42. The reformed gas is supplied from the reforming device 12, through the reformed gas passage 48 and the anode inlet 44a, and to the anode 40. Air (oxygen-containing gas) is supplied from the blower 56 through the cathode inlet passage 52 to the cathode 42.

The combination fuel cell and ion pump 14 generates electricity according to an electrochemical reaction between hydrogen contained in the reformed gas supplied to the anode 40 and oxygen contained in the air supplied to the cathode 42. The electrical energy generated by the combination fuel cell and ion pump 14 may be used as energy for domestic purposes, for example.

The air used by the cathode 42 is discharged out of the hydrogen and power generation system from the cathode outlet 46b and through the cathode off-gas passage 62. The reformed gas (containing unburned hydrogen gas) used by the anode 40 is delivered as an unburned gas from the anode outlet 44b, through the anode off-gas passage 50, and to the catalytic combustor 30.

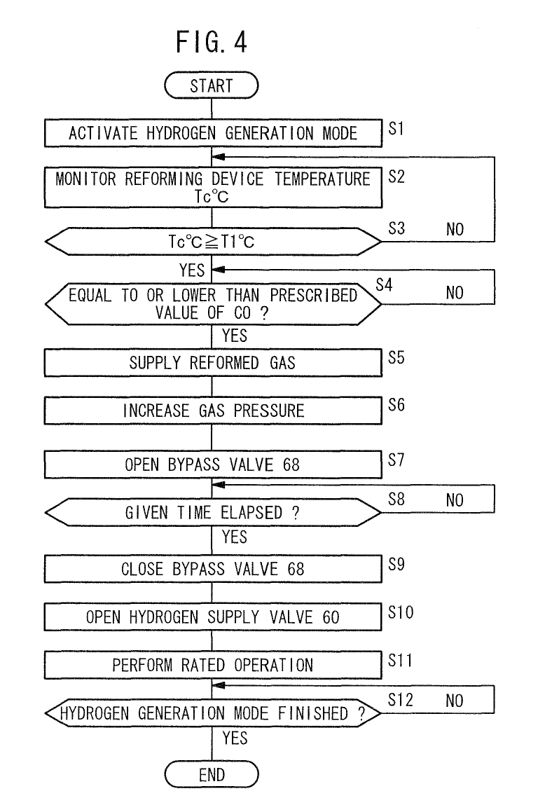

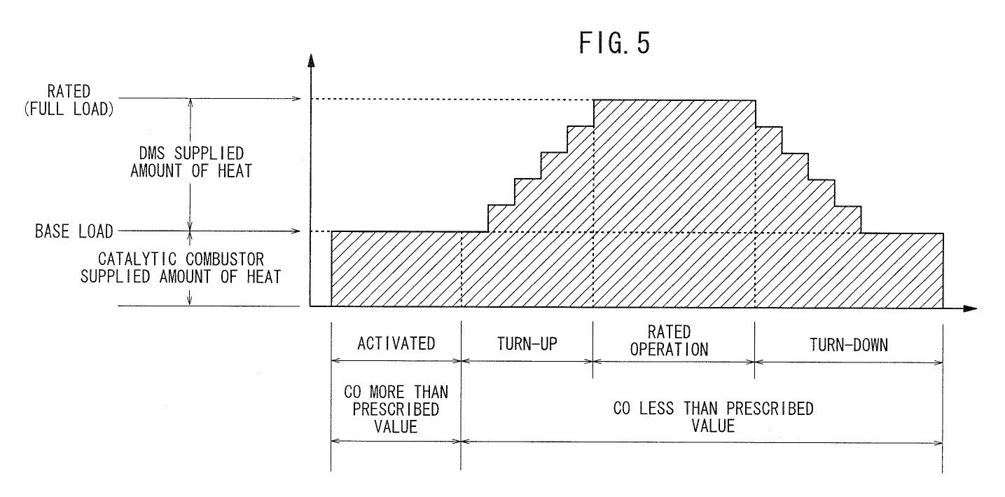

A control process for activating the hydrogen generation mode of the hydrogen and power generation system 10 will be described below with reference to the flowchart shown in FIG. 4 and the timing chart shown in FIG. 5.

First, in step S1, the hydrogen and power generation system 10 initiates activation in the hydrogen generation mode. When the hydrogen and power generation system 10 initially is activated in the hydrogen generation mode, the reforming device 12 operates with a minimum amount of heat required for stable operation (under a so-called base load). At this time, the reformed gas produced by the reforming device 12 contains a predetermined level or more of CO therein.

In step S2, the controller 16 detects the temperature Tc° C. of the catalytic combustor 30 using the temperature sensor 37 in order to monitor the reforming device 12. Instead of the temperature of the catalytic combustor 30, a period of time that has elapsed from the start of operation of the reforming device 12, or a pressure of the reformed gas produced by the reforming device 12, may also be used as a parameter for monitoring the reforming device 12.

If the controller 16 judges that the temperature Tc° C. of the catalytic combustor 30 detected by the temperature sensor 37 is equal to or higher than a preset temperature T1° C. in step S3 (YES), then in step S4, the controller 16 determines whether or not the CO concentration in the reformed gas produced by the reforming device 12 is equal to or lower than a predetermined level. If the controller 16 judges that the CO concentration in the reformed gas produced by the reforming device 12 is equal to or lower than the predetermined level in step S4 (YES), then in step S5, the reforming device 12 supplies the reformed gas to the anode inlet 44a of the combination fuel cell and ion pump 14. At this time, the solenoid-operated valves 54, 60, 64, 68 are closed.

Next, the combination fuel cell and ion pump 14 produces a refined hydrogen gas in the cathode 42. The load on the reforming device 12 increases stepwise or continuously (turn-up) as shown in FIG. 5. Specifically, the reformable raw fuel supplied to the reforming device 12 increases. At this time, in step S6, the combination fuel cell and ion pump 14 increases the pressure of the refined hydrogen gas in the cathode 42.

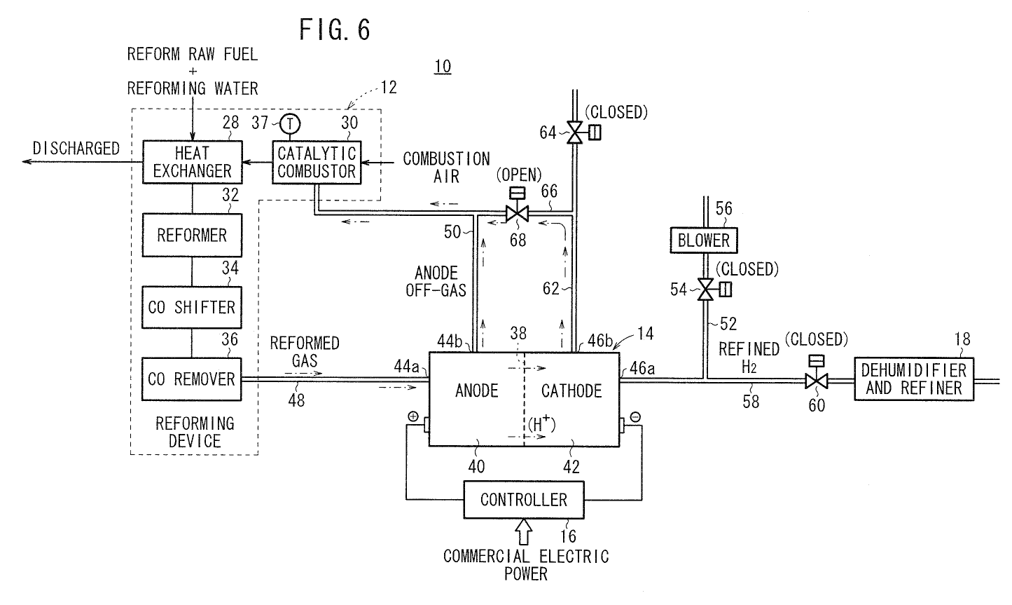

In step S7, the controller 16 opens the solenoid-operated valve (bypass valve) 68 (see FIG. 6). Therefore, the refined hydrogen gas in the cathode 42 of the combination fuel cell and ion pump 14 is discharged (purged), together with the gas remaining in the cathode 42, into the cathode off-gas passage 62. The hydrogen gas then flows through the cathode purge passage 66 into the anode off-gas passage 50, and is supplied as an unburned gas to the catalytic combustor 30.

After the refined hydrogen gas in the cathode 42 of the combination fuel cell and ion pump 14 has been purged for a predetermined period of time in step S8 (YES), the controller 16 closes the solenoid-operated valve (bypass valve) 68 in step S9, and opens the solenoid-operated valve (hydrogen supply valve) 60 in step S10. Therefore, the hydrogen gas refined by the combination fuel cell and ion pump 14 is supplied through the hydrogen gas passage 58 to the dehumidifier and refiner 18, which dehumidifies and refines the hydrogen gas. The hydrogen gas from the dehumidifier and refiner 18 is compressed by the compressor 20, and then is supplied to the filler 24.

As shown in FIG. 5, in step S11, the reforming device 12 now enters a rated mode of operation with a constant output. When the hydrogen and power generation system 10 is shut down, the load on the reforming device 12 gradually is reduced from a rated load level (turn-down). After the reforming device 12 has operated under the base load, the hydrogen generation mode is completed in step S12 (YES).

According to the first embodiment, when the hydrogen generation mode of the hydrogen and power generation system 10 is activated, the refined hydrogen gas in the cathode 42 of the combination fuel cell and ion pump 14 is discharged, together with the gas remaining in the cathode 42, from the cathode off-gas passage 62, through the cathode purge passage 66, and into the catalytic combustor 30.

Therefore, low-purity hydrogen gas remaining in the cathode 42 of the combination fuel cell and ion pump 14 is reliably purged from the cathode 42. Consequently, low-purity hydrogen gas, which contains nitrogen gas, etc., is reliably prevented from being supplied to the dehumidifier and refiner 18 connected downstream of the combination fuel cell and ion pump 14.

According to the present embodiment, hydrogen gas having a predetermined purity level can be supplied to the dehumidifier and refiner 18 more economically and in a shorter period of time than if the low-purity hydrogen gas remaining in the cathode 42 were diluted by hydrogen gas refined by the combination fuel cell and ion pump 14, so as to produce hydrogen gas of a predetermined purity level.

Furthermore, hydrogen gas discharged from the cathode 42 is delivered through the cathode purge passage 66 into the anode off-gas passage 50, and is supplied as an unburned gas to the catalytic combustor 30, to which the anode off-gas passage 50 is connected. Therefore, the hydrogen gas can efficiently and economically be utilized as a purge gas. Since the purge gas is not discharged outside of the hydrogen and power generation system 10, a purge gas processing facility is not required.

When the hydrogen and power generation system 10 starts to be activated in the electricity generation mode, the blower 56 operates to supply air to the cathode 42 of the combination fuel cell and ion pump 14. Gas remaining in the cathode 42 (low-purity hydrogen gas) is forced by the air supplied into the cathode 42, so as to flow from the cathode off-gas passage 62, through the cathode purge passage 66, and into the catalytic combustor 30. Therefore, the cathode 42 of the combination fuel cell and ion pump 14 can be scavenged reliably in a short period of time, thereby allowing the hydrogen and power generation system 10 to initiate rated operation in the electricity generation mode.

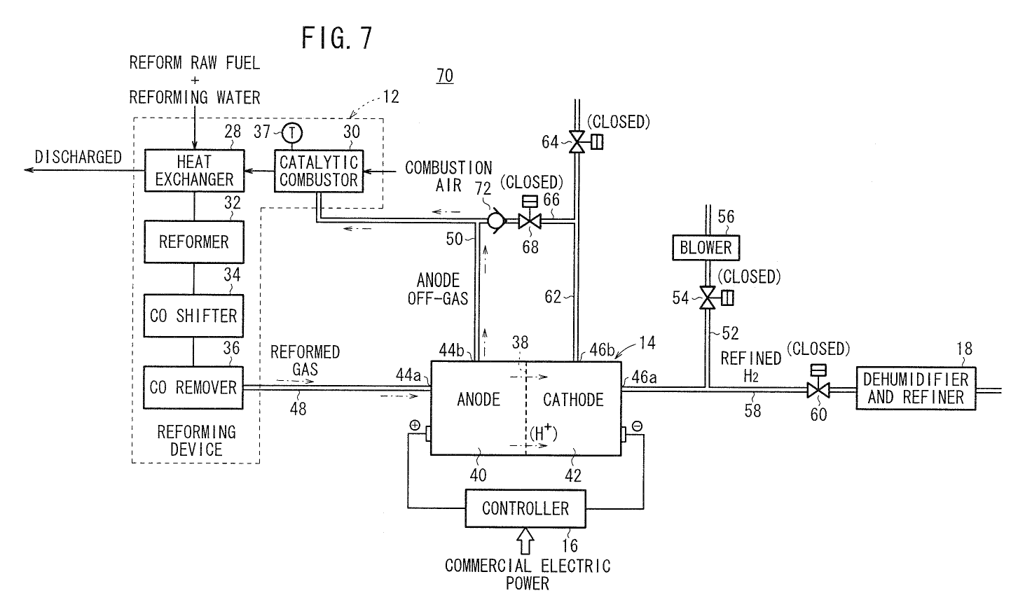

FIG. 7 shows in block form a hydrogen and power generation system 70 according to a second embodiment of the present invention. Parts of the hydrogen and power generation system 70 which are identical to those of the hydrogen and power generation system 10 according to the first embodiment are denoted by the same reference characters, and such features will not be described in detail below. Similarly, parts of the hydrogen and power generation systems according to the third and fourth embodiments, to be described below, which are identical to those of the hydrogen and power generation system 10 according to the first embodiment, are denoted by the same reference characters, and such features will not be described in detail below.

As shown in FIG. 7, the hydrogen and power generation system 70 includes a solenoid-operated valve (bypass valve) 68 and a check valve 72 connected to the cathode purge passage 66. The check valve 72 is disposed between the catalytic combustor 30 and the solenoid-operated valve 68. The solenoid-operated mechanism 68 may also include a reverse pressure-incompatible structure.

According to the second embodiment, the check valve 72 is connected to the cathode purge passage 66 downstream of the solenoid-operated mechanism 68 with respect to the direction in which the cathode off-gas flows. Therefore, the anode off-gas, which is discharged from the anode outlet 44b of the combination fuel cell and ion pump 14 into the anode off-gas passage 50, is prevented from flowing through the cathode purge passage 66 and the cathode outlet 46b into the cathode 42. Therefore, insofar as possible, the combination fuel cell and ion pump 14 is prevented from becoming degraded. The hydrogen and power generation system 70 also offers the same advantages as the hydrogen and power generation system 10 according to the first embodiment.

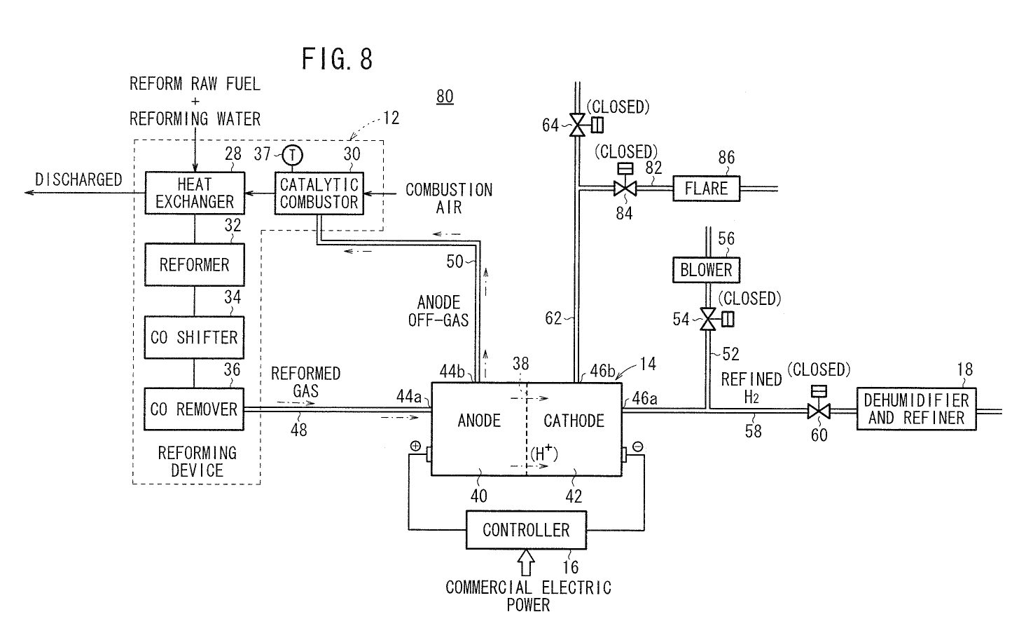

FIG. 8 shows in block form a hydrogen and power generation system 80 according to a third embodiment of the present invention.

As shown in FIG. 8, the hydrogen and power generation system 80 has a cathode purge passage 82 that branches from the cathode off-gas passage 62, together with a solenoid-controlled valve 84 and a flare combustor 86, which are connected to the cathode purge passage 82.

When the hydrogen generation mode of the hydrogen and power generation system 80 is activated, the solenoid-operated valves 54, 60, 64, 84 are closed, and the reforming device 12 supplies the reformed gas to the anode 40 of the combination fuel cell and ion pump 14. Therefore, as with the first embodiment, hydrogen ions move from the anode 40 toward the cathode 42, which generates refined hydrogen gas.

After the pressure of the hydrogen gas in the cathode 42 has increased, the solenoid-operated valve 84 is opened. Therefore, the low-purity hydrogen gas remaining in the cathode 42 is discharged into the flare combustor 86, together with the refined hydrogen gas, through the cathode off-gas passage 62 and the cathode purge passage 82. The flare combustor 86 burns the hydrogen gas introduced thereto, and discharges the exhaust gas.

According to the third embodiment, the hydrogen and power generation system 80 can reliably produce hydrogen gas having a predetermined purity level economically and in a short period of time. Thus, the third embodiment offers the same advantages as the first and second embodiments. Although the hydrogen and power generation system 80 according to the third embodiment employs the flare combustor 86, the cathode purge passage 82 may also be directly vented to the atmosphere.

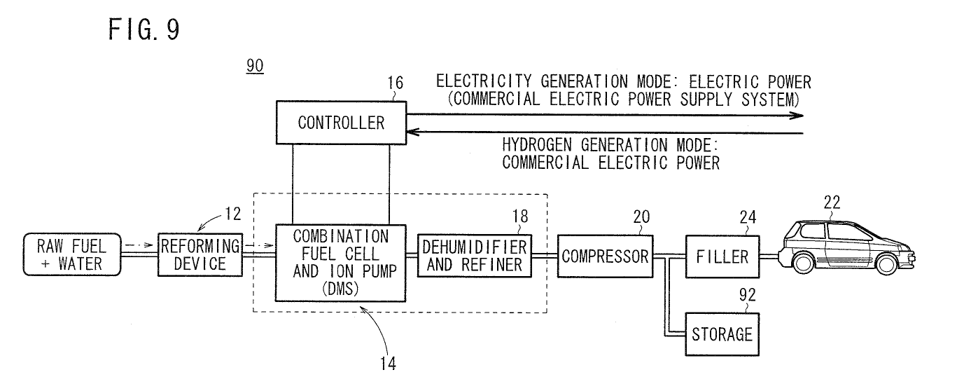

FIG. 9 shows in block form a hydrogen and power generation system 90 according to a fourth embodiment of the present invention.

As shown in FIG. 9, the hydrogen and power generation system 90 comprises a reforming device 12, a combination fuel cell and ion pump 14, a controller 16, a dehumidifier and refiner 18, a compressor 20, a filler 24, and a storage 92, which branches off from the compressor 20. The storage 92 comprises a tank for temporarily storing the refined hydrogen gas and for supplying the stored hydrogen gas to the filler 24, when necessary.

Although certain preferred embodiments of the present invention have been shown and described in detail, it should be understood that various changes and modifications may be made to the embodiments without departing from the scope of the invention as set forth in the appended claims.

What is claimed is:

1. A hydrogen and power generation system comprising:
a reforming device for producing a reformed gas by reforming a raw fuel mainly composed of hydrocarbons, the reforming device having a combustor as a heat source;
a combination fuel cell and ion pump comprising an electrolyte electrode assembly having an electrolyte and a pair of anode and cathode disposed on respective opposite sides of the electrolyte, the combination fuel cell and ion pump being operable selectively in a hydrogen generation mode for delivering hydrogen in the reformed gas through the electrolyte to the cathode by supplying the reformed gas to the anode while applying a potential between the anode and the cathode, and an electricity generation mode for generating electricity by supplying the reformed gas to the anode and supplying an oxygen-containing gas to the cathode while applying a potential between the anode and the cathode;
an anode off-gas passage for supplying an anode off-gas discharged from the anode to the combustor;
a cathode off-gas passage for discharging a cathode off-gas from the cathode, the cathode off-gas passage having a cut-off mechanism connected thereto;
a cathode purge passage connected to the cathode off-gas passage upstream of the cut-off mechanism; and
a valve mechanism connected to the cathode purge passage.

2. A hydrogen and power generation system according to claim 1, wherein the cathode purge passage is connected to the anode off-gas passage.

3. A hydrogen and power generation system according to claim 1, wherein the valve mechanism comprises a bypass valve and a check valve.

4. A hydrogen and power generation system according to claim 3, wherein the check valve is connected downstream of the bypass valve with respect to a direction in which the cathode off-gas flows through the cathode purge passage.

5. A hydrogen and power generation system according to claim 1, further comprising:
a combustor connected to the cathode purge passage.

6. A method of activating a hydrogen generation mode of a hydrogen and power generation system including a reforming device for producing a reformed gas by reforming a raw fuel mainly composed of hydrocarbons, the reforming device having a combustor as a heat source, a combination fuel cell and ion pump comprising an electrolyte electrode assembly having an electrolyte and a pair of anode and cathode disposed on respective opposite sides of the electrolyte, the combination fuel cell and ion pump being operable selectively in a hydrogen generation mode for delivering hydrogen in the reformed gas through the electrolyte to the cathode by supplying the reformed gas to the anode while applying a potential between the anode and the cathode, and an electricity generation mode for generating electricity by supplying the reformed gas to the anode and supplying an oxygen-containing gas to the cathode while applying a potential between the anode and the cathode, an anode off-gas passage for supplying an anode off-gas discharged from the anode to the combustor, a cathode off-gas passage for discharging a cathode off-gas from the cathode, the cathode off-gas passage having a cut-off mechanism connected thereto, a cathode purge passage connected to the cathode off-gas passage upstream of the cut-off mechanism, and a valve mechanism connected to the cathode purge passage, the method comprising the step of:
supplying the reformed gas to the anode of the combination fuel cell and ion pump, thereby discharging refined hydrogen in the cathode into the cathode off-gas passage.

7. A method according to claim 6, further comprising the step of:
opening the cut-off mechanism to introduce the hydrogen discharged into the cathode off-gas passage through the cathode purge passage and into the anode off-gas passage.
